(19) United States
(12) Patent Application Publication
(10) Pub. No.: US 2024/0085610 A1
(43) Pub. Date: Mar. 14, 2024

(54) Photonic Package and Method of Manufacture

(71) Applicant: Taiwan Semiconductor Manufacturing Co., Ltd., Hsinchu (TW)

(72) Inventors: Chen-Hua Yu, Hsinchu (TW); Hsing-Kuo Hsia, Jhubei City (TW)

(21) Appl. No.: 18/153,116

(22) Filed: Jan. 11, 2023

Related U.S. Application Data
(60) Provisional application No. 63/381,949, filed on Nov. 2, 2022.
(60) Provisional application No. 63/375,425, filed on Sep. 13, 2022.

(51) Int. Cl. F21V 8/00; G02B 6/124; G02B 6/42

(52) U.S. Cl. CPC G02B 6/0006; G02B 6/124; G02B 6/4214; G02B 6/4244; G02B 6/4283

(57) ABSTRACT

A method includes receiving a workpiece that includes a substrate, a first dielectric layer over the substrate, and an optical layer over the dielectric layer; patterning the optical layer to form a first waveguide and a grating coupler; forming a first opening in the substrate that exposes the first dielectric layer, wherein at least a portion of the first opening is directly over the grating coupler; depositing a metal layer in the first opening; and depositing a second dielectric layer over the metal layer.

### PRIORITY CLAIM AND CROSS-REFERENCE

This application claims the benefits of U.S. Provisional Application No. 63/381,949, filed on Nov. 2, 2022, and U.S. Provisional Application No. 63/375,425, filed on Sep., 13 2022, which applications are hereby incorporated herein by reference in their entirety.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating optical components and electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1 through 15 illustrate cross-sectional views of a photonic package at various stages of manufacturing, in accordance with an embodiment.

FIG. 16 illustrates a cross-sectional view of a photonic package, in accordance with another embodiment.

FIGS. 17 through 19 illustrate cross-sectional views of a photonic package at various stages of manufacturing, in accordance with an embodiment.

FIGS. 20 through 24 illustrate cross-sectional views of a photonic package at various stages of manufacturing, in accordance with an embodiment.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Throughout the description herein, unless otherwise specified, the same or similar reference numerals in different figures refer to the same or similar element formed by a same or similar formation method using a same or similar material(s).

In aspects of this disclosure, a photonic package includes a reflector formed beneath a grating coupler. The presence of the reflector can improve the optical coupling efficiency between the grating coupler and an overlying optical structure, such as an optical fiber. The techniques described herein allow for the formation of a reflector that is as close to a grating coupler as desired. In some cases, forming a reflector closer to a grating coupler can increase the optical coupling efficiency more than a reflector formed farther away from the grating coupler. The techniques described herein also allow for the formation of a reflector and a variety of photonic structures within a photonic package, such as photonic routing structures, silicon nitride waveguides, or the like. In this manner, the efficiency and performance of a photonic package can be improved.

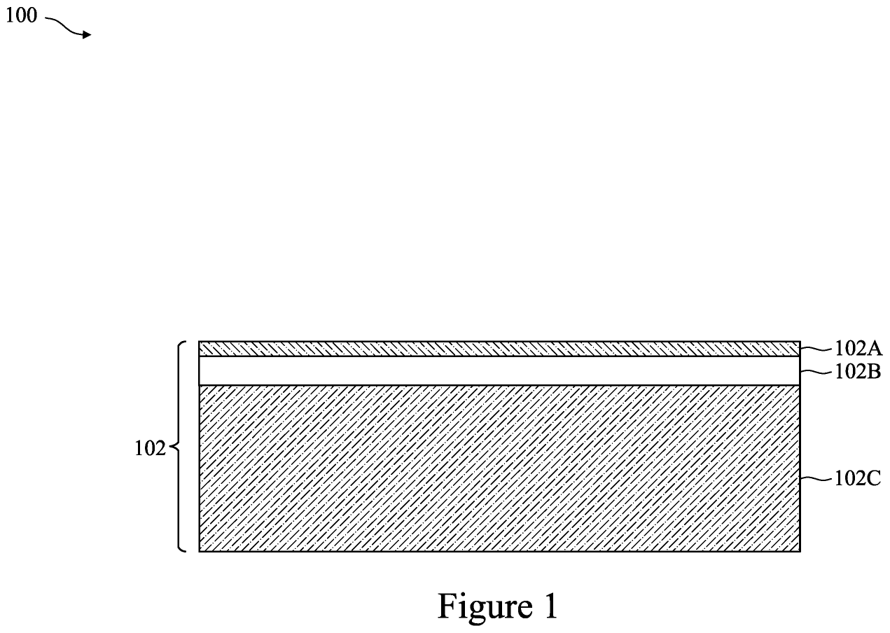

FIGS. 1 through 15 illustrate cross-sectional views of a photonic package 100 at various stages of manufacturing, in accordance with an embodiment. In some cases, the photonic package 100 (also referred to as an optical engine) may be part of a semiconductor package or other structure. In some embodiments, the photonic package 100 provides an input/output (I/O) interface between optical signals and electrical signals in a semiconductor package. In some embodiments, the photonic package 100 provides an optical network for signal communication between components (e.g., photonic devices, integrated circuits, couplings to external fibers, etc.) within the photonic package 100. In some cases, the photonic package 100 may be considered an “optical engine.”

Turning first to FIG. 1, a buried oxide (“BOX”) substrate 102 is provided, in accordance with some embodiments. The BOX substrate 102 includes an oxide layer 102B formed over a substrate 102C, and a silicon layer 102A formed over the oxide layer 102B. The substrate 102C may be, for example, a material such as a glass, ceramic, dielectric, a semiconductor, the like, or a combination thereof. In some embodiments, the substrate 102C may be a semiconductor substrate, such as a bulk semiconductor or the like, which may be doped (e.g., with a p-type or an n-type dopant) or undoped. The substrate 102C may be a wafer, such as a silicon wafer (e.g., a 12-inch silicon wafer). Other substrates, such as a multi-layered or gradient substrate may also be used. In some embodiments, the semiconductor material of the substrate 102C may include silicon; germanium; a compound semiconductor including silicon carbide, gallium arsenic, gallium phosphide, indium phosphide, indium arsenide, and/or indium antimonide; an alloy semiconductor including silicon germanium, gallium arsenide phosphide, aluminum indium arsenide, aluminum gallium arsenide, gallium indium arsenide, gallium indium phosphide, and/or gallium indium arsenide phosphide; or combinations thereof. The substrate 102C may have a thickness in the range of about 300 μm to about 2000 μm, in some embodiments. The oxide layer 102B may be, for example, a silicon oxide or the like. In some embodiments, the oxide layer 102B may have a thickness in the range of about 0.5 μm to about 4 μm, in some embodiments. The silicon layer 102A may have a thickness in the range of about 0.1 μm to about 1.5 μm, in some embodiments. Other thicknesses are possible. The BOX substrate 102 may be referred to as having a front side or front surface (e.g., the side facing upwards in FIG. 1), and a back-side or back surface (e.g., the side facing downwards in FIG. 1).

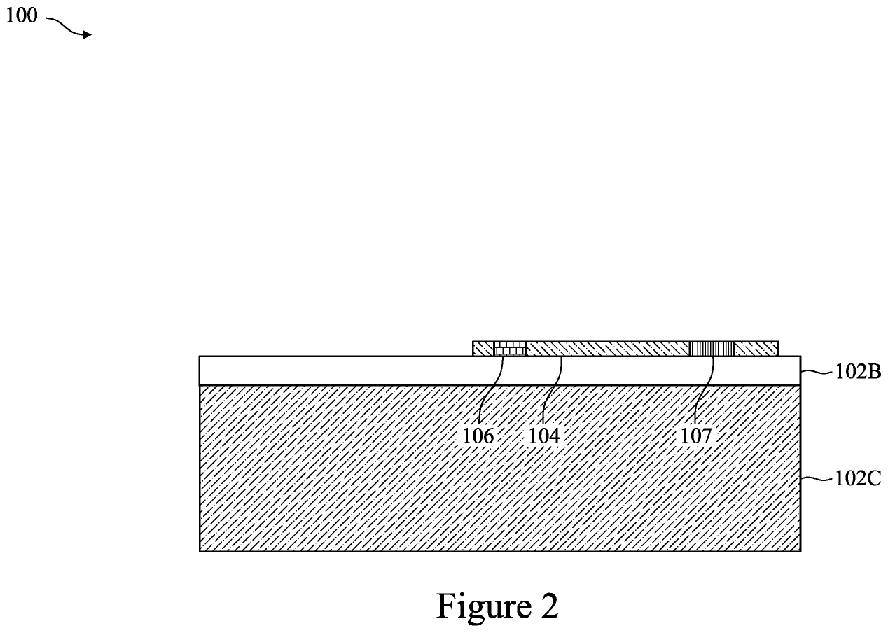

In FIG. 2, the silicon layer 102A is patterned to form silicon regions for waveguides 104, photonic components 106, and grating couplers 107, in accordance with some embodiments. In this manner, the silicon layer 102A may be considered an “optical layer” in some cases. The silicon layer 102A may be patterned using suitable photolithography and etching techniques. For example, a hardmask layer (e.g., a nitride layer or other dielectric material, not shown in FIG. 2) may be formed over the silicon layer 102A and patterned, in some embodiments. The pattern of the hardmask layer may then be transferred to the silicon layer 102A using an etching process. The etching process may include, for example, a dry etching process and/or a wet etching process. The etching process may be anisotropic. For example, the silicon layer 102A may be etched to form recesses defining the waveguides 104 (also referred to as silicon waveguides 104), with sidewalls of the remaining unrecessed portions defining sidewalls of the waveguides 104. In some embodiments, more than one photolithography and etching sequence may be used in order to pattern the silicon layer 102A.

One waveguide 104 or multiple waveguides 104 may be patterned from the silicon layer 102A. If multiple waveguides 104 are formed, the multiple waveguides 104 may be individual separate waveguides 104 or connected as a single continuous structure. In some embodiments, one or more of the waveguides 104 form a continuous loop. Other configurations or arrangements of waveguides 104, the photonic components 106, or the grating couplers 107 are possible, and other types of photonic components 106 or photonic structures may be formed. In some cases, the waveguides 104, the photonic components 106, and the grating couplers 107 may be collectively referred to as “the photonic layer” or as a “photonic integrated circuit (PIC).”

The photonic components 106 may be integrated with the waveguides 104, and may be formed with the silicon waveguides 104. The photonic components 106 may be optically coupled to the waveguides 104 and may interact with optical signals within the waveguides 104. The photonic components 106 may include, for example, photonic devices such as photodetectors, modulators, other photonic devices, or the like. For example, a photodetector may be optically coupled to the waveguides 104 to detect optical signals within the waveguides 104 and generate electrical signals corresponding to the optical signals. As another example, a modulator may be optically coupled to the waveguides 104 to receive electrical signals and generate corresponding optical signals within the waveguides 104 by modulating optical power within the waveguides 104. In this manner, the photonic components 106 can facilitate the input/output (I/O) of optical signals to and from the waveguides 104. In other embodiments, the photonic components may include other active or passive components, such as laser diodes, optical signal splitters, phase shifters, interferometers, oscillators, or other types of photonic structures or devices.

In some embodiments, photodetectors may be formed by partially etching regions of the waveguides 104 and growing epitaxial material on the remaining silicon of the etched regions. The waveguides 104 may be etched using acceptable photolithography and etching techniques. The epitaxial material may comprise, for example, a semiconductor material such as germanium, which may be doped or undoped. In some embodiments, an implantation process may be performed to introduce dopants within the silicon of the etched regions as part of the formation of the photodetectors. The silicon of the etched regions may be doped with p-type dopants, n-type dopants, or a combination. In some embodiments, modulators may be formed by, for example, partially etching regions of the waveguides 104 and then implanting appropriate dopants within the remaining silicon of the etched regions. The waveguides 104 may be etched using acceptable photolithography and etching techniques. In some embodiments, the etched regions used for the photodetectors and the etched regions used for the modulators may be formed using one or more of the same photolithography or etching steps. The silicon of the etched regions may be doped with p-type dopants, n-type dopants, or a combination thereof. In some embodiments, the etched regions used for the photodetectors and the etched regions used for the modulators may be implanted using one or more of the same implantation steps.

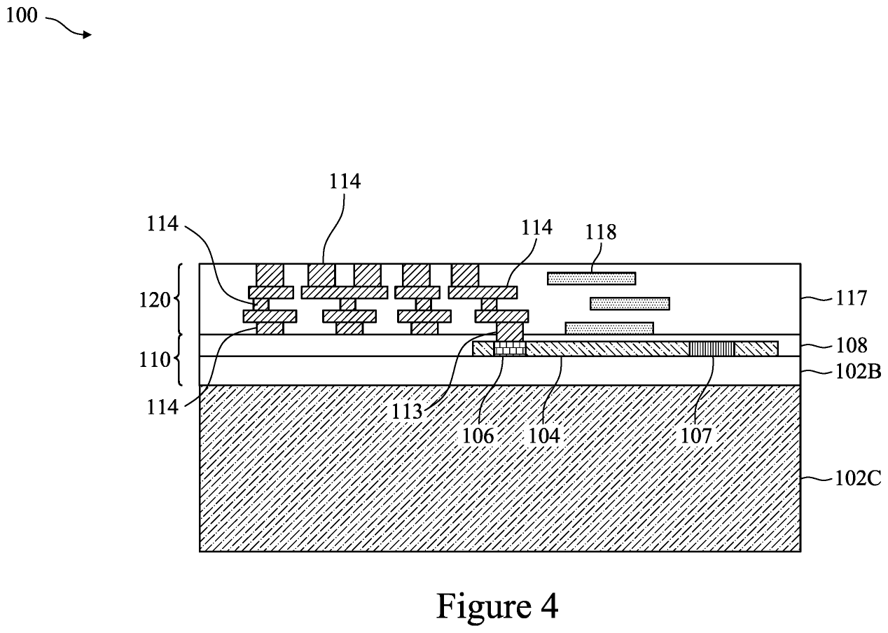

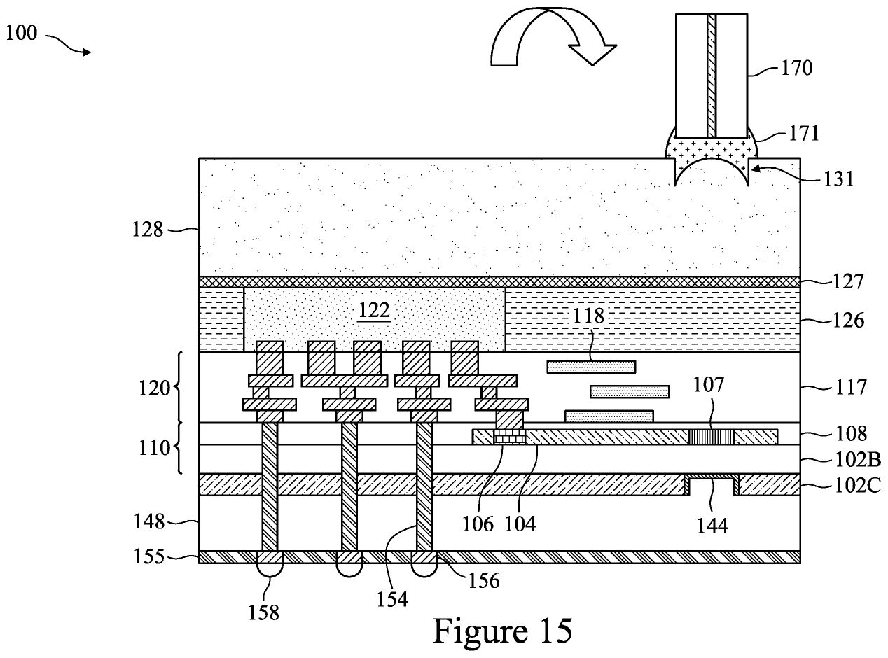

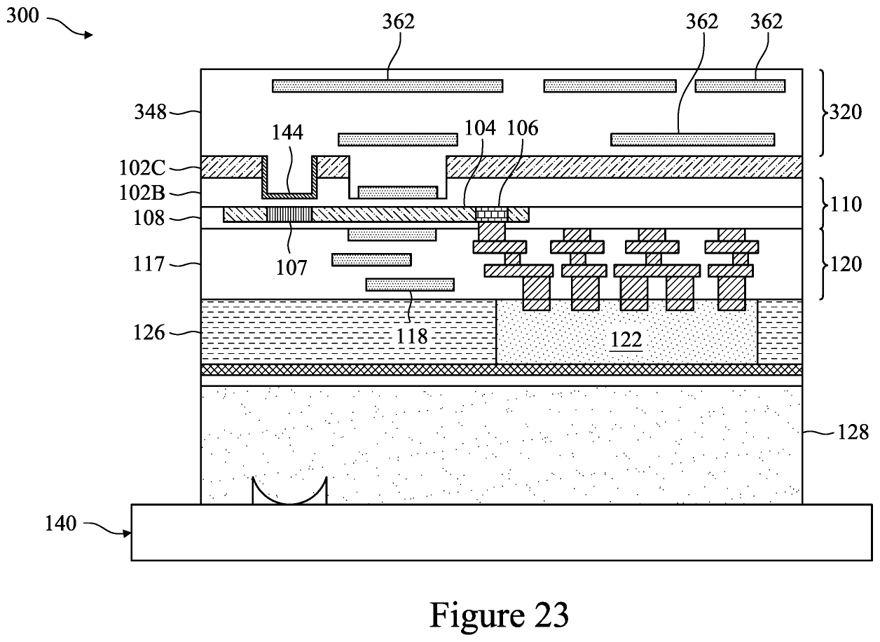

In some embodiments, one or more grating couplers 107 may be formed with the waveguides 104. The grating couplers 107 are photonic structures that allow optical signals and/or optical power to be transferred between the waveguides 104 and another photonic component, such as a vertically-mounted optical fiber (e.g., the optical fiber 170 shown in FIG. 15) or a waveguide of another photonic system. The grating couplers 107 may be formed using acceptable photolithography and etching techniques. In an embodiment, the grating couplers 107 are formed after the waveguides 104 are defined. For example, a photoresist may be formed on the waveguides 104 and patterned, with the pattern of the photoresist corresponding to the grating couplers 107. One or more etching processes may then be performed on the waveguides 104 using the patterned photoresist as an etching mask to form the grating couplers 107. The etching processes may include one or more dry etching processes and/or wet etching processes, which may include anisotropic processes. In some embodiments, other types of couplers (not individually labeled in the figures) may be formed, such as a structure that couples optical signals between the waveguides 104 and other waveguides of the photonic package 100, such as nitride waveguides (e.g., see FIGS. 4 and 23). Edge couplers (not shown in the figures) may also be formed that allow optical signals and/or optical power to be transferred between the waveguide 104 and a photonic component that is horizontally mounted near a sidewall of the photonic package 100. These and other photonic structures are considered within the scope of the present disclosure.

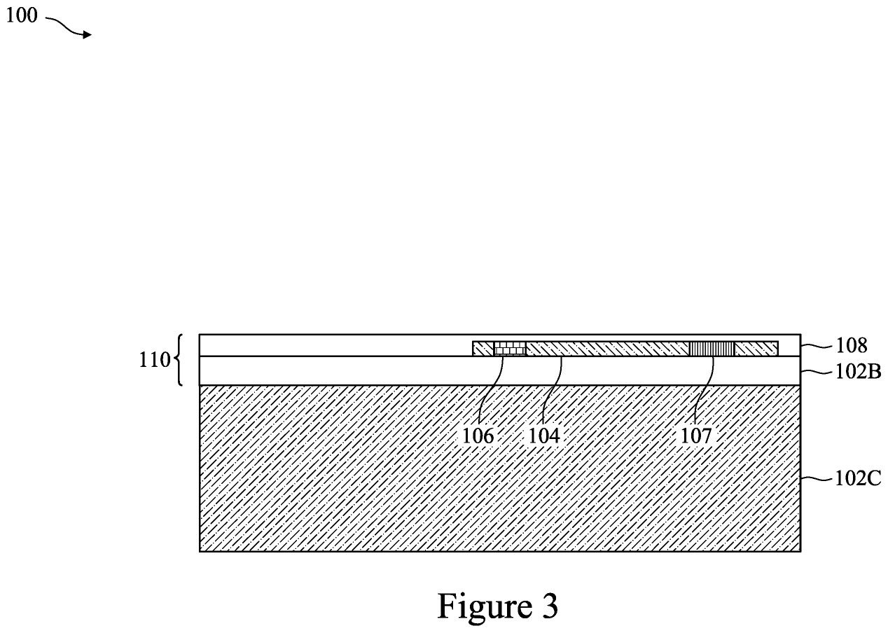

In FIG. 3, a dielectric layer 108 is formed on the front side of the BOX substrate 102 to form a photonic routing structure 110, in accordance with some embodiments. The dielectric layer 108 is formed over the waveguides 104, the photonic components 106, the grating couplers 107, and the oxide layer 102B. The dielectric layer 108 may be formed of one or more layers of silicon oxide, silicon nitride, a combination thereof, or the like, and may be formed by CVD, PVD, atomic layer deposition (ALD), a spin-on-dielectric process, the like, or a combination thereof. In some embodiments, the dielectric layer 108 may be formed by a high density plasma chemical vapor deposition (HDP-CVD), a flowable CVD (FCVD) (e.g., a CVD-based material deposition in a remote plasma system and post curing to convert it to another material, such as an oxide), the like, or a combination thereof. Other dielectric materials formed by any acceptable process may be used. In some embodiments, the dielectric layer 108 is then planarized using a planarization process such as a chemical-mechanical polish (CMP) process, a grinding process, or the like. The dielectric layer 108 may be formed having a thickness over the oxide layer 102B in the range of about 50 nm to about 500 nm, or may be formed having a thickness over the waveguides 104 in the range of about 10 nm to about 200 nm, in some embodiments. In some cases, a thinner dielectric layer 108 may allow for more efficient optical coupling between a grating coupler 107 and a vertically-mounted photonic component, or more efficient optical coupling between the waveguides 104 and overlying waveguides, such as the nitride waveguides 118 described below (see FIG. 4). In other embodiments, the planarization process may expose surfaces of the waveguides 104, the photonic components 106, and/or the grating couplers 107.

Due to the difference in refractive indices of the materials of the waveguides 104 and dielectric layer 108, the waveguides 104 have high internal reflections such that light is substantially confined within the waveguides 104, depending on the wavelength of the light and the refractive indices of the respective materials. In an embodiment, the refractive index of the material of the waveguides 104 is higher than the refractive index of the material of the dielectric layer 108. For example, the waveguides 104 may comprise silicon, and the dielectric layer 108 may comprise silicon oxide and/or silicon nitride. Accordingly, the waveguides 104 may be referred to as “silicon waveguides” herein.

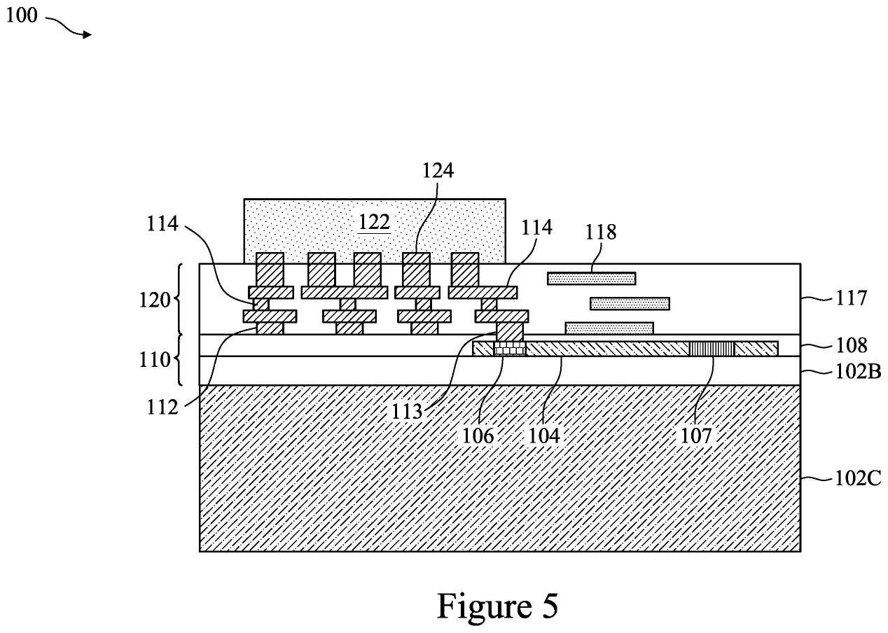

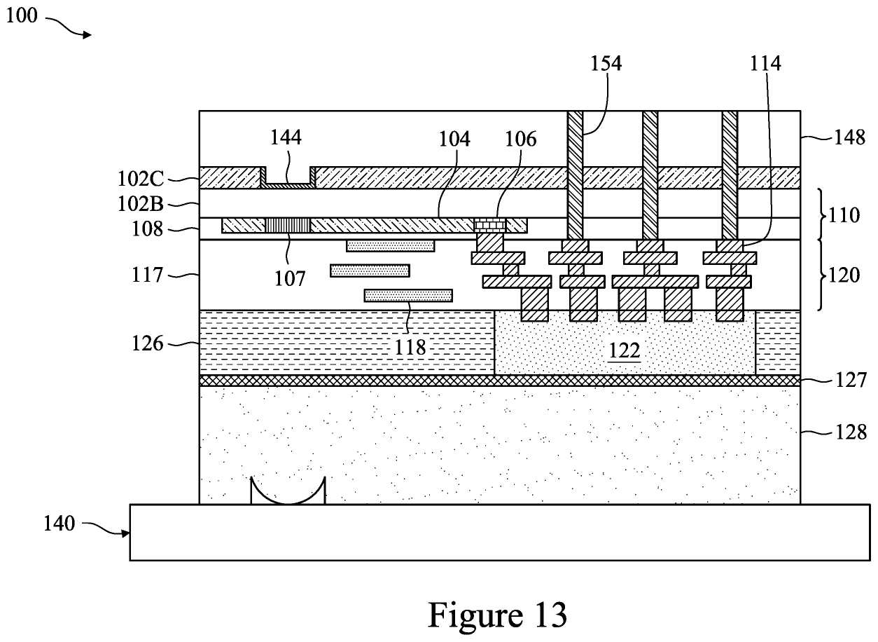

In FIG. 4, a redistribution structure 120 is formed over the dielectric layer 108, in accordance with some embodiments. The redistribution structure 120 is an interconnect structure that includes one or more dielectric layers (collectively shown and referred to as “dielectric layers 117”) and includes conductive features 114 formed in the dielectric layers 117 that provide interconnections and electrical routing. For example, conductive features 114 of the redistribution structure 120 may include contacts 113 that are electrically connected to photonic devices 106, in some embodiments. The redistribution structure 120 may also provide electrical connection to underlying features such as vias 154 (see FIG. 13) and/or overlying features such as electronic dies 122 (see FIG. 5). The dielectric layers 117 may be, for example, insulating or passivating layers, and may comprise one or more materials similar to those described above for the dielectric layer 108, such as a silicon oxide or a silicon nitride, or may comprise a different material. The dielectric layers 117 and/or the dielectric layer 108 may be transparent or nearly transparent to light within the same range of wavelengths. The dielectric layers 117 may be formed using a technique similar to those described above for the dielectric layer 108 or using a different technique.

The conductive features 114 may include conductive lines and vias, and may be formed by a damascene process, e.g., single damascene, duel damascene, or the like. The conductive features 114 may be formed, for example, depositing a dielectric layer 117 and then forming openings extending through the dielectric layer 117. The openings may be formed using acceptable photolithography and etching techniques, such as by forming and patterning a photoresist and then performing an etching process using the patterned photoresist as an etching mask. The etching process may include, for example, a dry etching process and/or a wet etching process. A conductive material may then be formed in the openings, thereby forming conductive features 114 in the dielectric layer 117, in accordance with some embodiments. In some embodiments, a liner (not shown), such as a diffusion barrier layer, an adhesion layer, or the like, may be formed in the openings from tantalum, tantalum nitride, titanium, titanium nitride, CoW, or the like, and may be formed using suitable a deposition process such as ALD or the like. In some embodiments, a seed layer (not shown), which may include copper or a copper alloy may then be deposited in the openings. The conductive material of the conductive features 114 may be formed in the openings using, for example, a plating process. The conductive material may include, for example, a metal or a metal alloy such as copper, silver, gold, tungsten, cobalt, aluminum, or alloys thereof. A planarization process (e.g., a CMP process or a grinding process) may be performed to remove excess conductive material along the top surface of the dielectric layer 117, such that top surfaces of the conductive features 114 and the dielectric layer 117 are level. Another dielectric layer 117 may be deposited over the conductive features 114, and a similar process may be performed to form additional conductive features 114. In this manner, the process may be repeated to form multiple layers of dielectric layers 117 and conductive features 114. The conductive features 114 may be formed using other techniques or materials in other embodiments.

In some embodiments, the top-most conductive features 114 of the redistribution structure 120 may include conductive pads, bonding pads, or the like. The top-most conductive features 114 may be formed in the top-most dielectric layer 117 of the redistribution structure 120. A planarization process (e.g., a CMP process or the like) may be performed after forming the top-most conductive features 114 such that surfaces of the top-most conductive features 114 and the top-most dielectric layer 117 are substantially level or coplanar. In some embodiments, the bottom-most conductive features 114 of the redistribution structure 120 may include conductive pads or the like. The bottom-most conductive features 114 may be formed in the bottom-most dielectric layer 117 of the redistribution structure 120. The redistribution structure 120 may include more or fewer dielectric layers 117 or conductive features 114 than shown in FIG. 4. The redistribution structure 120 may be formed having a thickness between about 4 μm and about 8 μm, in some embodiments. Other thicknesses are possible.

In some embodiments, the bottom-most conductive features 114 of the redistribution structure 120 includes contacts 113 that extend through the dielectric layer 108 and are electrically connected to the photonic components 106. The contacts 113 allow electrical power or electrical signals to be transmitted to the photonic components 106 and electrical signals to be transmitted from the photonic components 106. In this manner, the photonic components 106 may convert electrical signals into optical signals transmitted by the waveguides 104, and/or may convert optical signals from the waveguides 104 into electrical signals. The contacts 113 may be formed before or after formation of the other bottom-most conductive features 114 of the redistribution structure 120. The formation of the contacts 113 and the formation of the other bottom-most conductive features 114 may share some steps such as deposition of the conductive material and/or planarization. In some embodiments, the contacts 113 are formed by a damascene process, e.g., single damascene, dual damascene, or the like. For example, in some embodiments, openings (not shown) for the contacts 113 are first formed in the dielectric layer 108 using acceptable photolithography and etching techniques. A conductive material may then be formed in the openings, forming the contacts 113. Excess conductive material may be removed using a CMP process or the like. The conductive material of the contacts 113 may be formed of a metal or a metal alloy including aluminum, copper, tungsten, or the like, which may be the same as that of the other bottom-most conductive features 114. The contacts 113 may be formed using other techniques or materials in other embodiments.

In some embodiments, one or more silicon nitride waveguides 118 (also referred to as “nitride waveguides”) may be formed within the redistribution structure 120. The nitride waveguides 118 may be formed within the dielectric layers 117, described in greater detail below. The nitride waveguides 118 within a dielectric layer 117 may be formed before or after the conductive features 114 that are within the same dielectric layer 117. In some embodiments, nitride waveguides 118 may be optically coupled to overlying or underlying nitride waveguides 118. In some embodiments, one or more of the bottom-most nitride waveguides 118 may be coupled to one or more underlying silicon waveguides 104. In this manner, the nitride waveguides 118 may be used to transmit optical signals and/or optical power to or from other nitride waveguides 118 and/or the silicon waveguide(s) 104.

In some cases, a waveguide formed from silicon nitride (e.g., nitride waveguides 118) may have advantages over a waveguide formed from silicon (e.g., waveguides 104). For example, silicon nitride has a higher dielectric constant than silicon, and thus a nitride waveguide may have a greater internal confinement of light than a silicon waveguide. This may also allow the performance or leakage of nitride waveguides to be less sensitive to process variations, less sensitive to dimensional uniformity, and less sensitive to surface roughness (e.g., edge roughness or linewidth roughness). In some cases, the reduced process sensitivity may allow nitride waveguides to be easier or less costly to process than silicon waveguides. These characteristics may allow a nitride waveguide to have a lower propagation loss than a silicon waveguide. In some cases, the propagation loss (dB/cm) of a nitride waveguide may be between about 0.1% and about 50% of a silicon waveguide. In some cases, a nitride waveguide may also be less sensitive to the temperature of the environment than a silicon waveguide. For example, a nitride waveguide may have a sensitivity to temperature that is as small as about 1% of that of a silicon waveguide. In this manner, the embodiments described herein can allow for the formation of a photonic package that has both nitride waveguides (e.g., nitride waveguides 118) and silicon waveguides (e.g., waveguides 104).

In some embodiments, a nitride waveguide 118 may be formed, for example, by depositing a layer of silicon nitride and then patterning the layer of silicon nitride to form the nitride waveguide 118. The silicon nitride layer may be formed using a suitable deposition technique, such as CVD, PECVD, LPCVD, PVD, or the like. In some embodiments, the silicon nitride layer is formed having a thickness in the range of about 0.2 μm to about 1.0 μm, though other thicknesses are possible. The layer of silicon nitride may be patterned using acceptable photolithography and etching techniques. For example, a hardmask layer (not shown) may be formed over the silicon nitride layer and patterned, in some embodiments. The pattern of the hardmask layer may then be transferred to the silicon nitride layer using an etching process. The etching process may include, for example, a dry etching process and/or a wet etching process. In some embodiments, the etching process may be selective to silicon nitride over silicon oxide or other materials. In this manner, the silicon nitride layer may be etched to form recesses defining the nitride waveguides 118, with sidewalls of the remaining unrecessed portions defining sidewalls of the nitride waveguides 118.

In some embodiments, more than one photolithography and etching sequence may be used in order to pattern the silicon nitride layer. One nitride waveguide 118 or multiple nitride waveguides 118 may be patterned from the silicon nitride layer. If multiple nitride waveguides 118 are formed, the multiple nitride waveguides 118 may be individual separate nitride waveguides 118 or connected as a single continuous structure. In some embodiments, one or more of the nitride waveguides 118 form a continuous loop. In some embodiments, nitride waveguides 118 may include photonic structures such as grating couplers, edge couplers, or couplers (e.g., mode converters) that allow optical signals to be transmitted between two nitride waveguides 118 and/or between a nitride waveguide 118 and a silicon waveguide 104.

After patterning the silicon nitride layer to form nitride waveguides 118, a dielectric layer 117 may be deposited over the nitride waveguides 118. The dielectric layer 117 may also be deposited over conductive features 114, as described previously for the formation of the conductive features 114. Another nitride waveguide 118 may be formed over the dielectric layer 117 using similar process steps. The number of layers of nitride waveguides 118 may be fewer, about the same, or more than the number of layers of conductive features 114 within the redistribution structure 120. In other embodiments, all of the nitride waveguides 118 are formed before or after forming all of the conductive features 114.

In FIG. 5, an electronic die 122 is bonded to the redistribution structure 120, in accordance with some embodiments. The electronic die 122 may be, for example, a semiconductor device, die, or chip that may communicate with the photonic components 106 using electrical signals. In some embodiments, the electronic die 122 may process electrical signals received from photonic components 106 or may generate electrical signals that photonic components 106 convert into optical signals. One electronic die 122 is shown in FIG. 5, but a photonic package 100 may include two or more electronic dies 122 in other embodiments. In some cases, multiple electronic dies 122 may be incorporated into a single photonic package 100 in order to reduce processing cost or increase functionality. The electronic die 122 includes die connectors 124, which may be, for example, conductive pads, conductive pillars, or the like. In some embodiments, the electronic die 122 may have a thickness in the range of about 10 μm to about 35 μm. Other thicknesses are possible.

The electronic die 122 may include integrated circuits for interfacing with the photonic components 106, such as circuits for controlling the operation of the photonic components 106. For example, the electronic die 122 may include controllers, drivers, transimpedance amplifiers, the like, or combinations thereof. The electronic die 122 may include a CPU or memory functionality, in some embodiments. In some embodiments, the electronic die 122 includes circuits for processing electrical signals received from photonic components 106, such as for processing electrical signals received from a photonic component 106 comprising a photodetector. The electronic die 122 may control high-frequency signaling of the photonic components 106 according to electrical signals (digital or analog) received from another device or die, in some embodiments. In some embodiments, the electronic die 122 may be an electronic integrated circuit (EIC) or the like that provides Serializer/Deserializer (SerDes) functionality. In this manner, the electronic die 122 may act as part of an I/O interface between optical signals and electrical signals within a photonic package 100. In some cases, the photonic packages 100 described herein can be considered system-on-chip (SoC) or system-on-integrated-circuit (SoIC) devices.

In some embodiments, the electronic die 122 is bonded to the redistribution structure 120 using dielectric-to-dielectric bonding and/or metal-to-metal bonding (e.g., direct bonding, fusion bonding, oxide-to-oxide bonding, hybrid bonding, or the like). In such embodiments, dielectric-to-dielectric bonding may occur between the top-most dielectric layer 117 and a bonding layer (not individually shown) of the electronic die 122. During the bonding, metal-to-metal bonding may also occur between the die connectors 124 of the electronic die 122 and the top-most conductive features 114 of the redistribution structure 120.

In some embodiments, before performing the bonding process, a surface treatment is performed on the redistribution structure 120 and/or the electronic die 122. In some embodiments, the bonding surfaces of the redistribution structure 120 and/or the electronic die 122 may first be activated utilizing, for example, a dry treatment, a wet treatment, a plasma treatment, exposure to an inert gas, exposure to H₂, exposure to N₂, exposure to O₂, the like, or a combination thereof. However, any suitable activation process may be utilized. After the activation process, the redistribution structure 120 and/or the electronic die 122 may be cleaned using, e.g., a chemical rinse. The electronic die 122 is then aligned with the redistribution structure 120 and placed into physical contact with the redistribution structure 120. The electronic die 122 may be placed on the redistribution structure 120 using a pick-and-place process, for example. The redistribution structure 120 and the electronic die 122 may then be subjected to a thermal treatment and/or pressed against each other (e.g., by applying contact pressure) to bond the redistribution structure 120 and the electronic die 122. For example, the redistribution structure 120 and the electronic die 122 may be subjected to a pressure of about 200 kPa or less, and to a temperature in the range of about 200° C. to about 400° C. The redistribution structure 120 and the electronic die 122 may then be subjected to a temperature at or above the eutectic point of the material of the top-most conductive features 114 and the die connectors 124 (e.g., a temperature in the range of about 150° C. to about 650° C.) to fuse the top-most conductive features 114 and the die connectors 124. In this manner, the dielectric-to-dielectric bonding and/or metal-to-metal bonding of the redistribution structure 120 and the electronic die 122 forms a bonded structure. In some embodiments, the bonded structure is baked, annealed, pressed, or otherwise treated to strengthen or finalize the bonds.

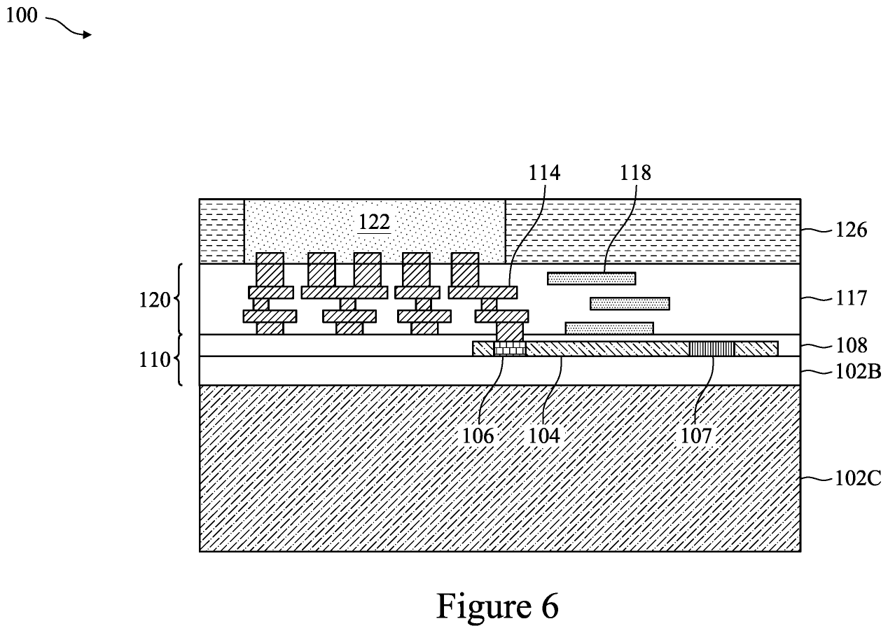

In FIG. 6, a dielectric material 126 is formed over the electronic die(s) 122 and the redistribution structure 120, in accordance with some embodiments. The dielectric material 126 may be formed of silicon oxide, silicon nitride, a polymer, the like, or a combination thereof. The dielectric material 126 may be formed by CVD, PVD, ALD, a spin-on process, the like, or a combination thereof. In some embodiments, the dielectric material 126 may be formed by HDP-CVD, FCVD, PECVD, the like, or a combination thereof. The dielectric material 126 may be a gap-fill material in some embodiments, which may include one or more of the example materials above. In some embodiments, the dielectric material 126 may be a material (e.g., silicon oxide) that is substantially transparent to light at wavelengths suitable for transmitting optical signals or optical power between the grating coupler 107 and a vertically-mounted optical fiber (e.g., optical fiber 170 in FIG. 15). The dielectric material 126 may be a material similar to that of the dielectric layers 117 and/or the dielectric layer 108, in some embodiments. Other dielectric materials formed by any acceptable processes may be used. The dielectric material 126 may be planarized using a planarization process such as a CMP process, a grinding process, or the like. In some embodiments, the planarization process may expose the electronic die 122 such that surfaces of the electronic die 122 and the dielectric material 126 are coplanar.

The use of dielectric-to-dielectric bonding for bonding the electronic die 122 may allow for materials transparent to the relevant wavelengths of light to be deposited over the redistribution structure 120 and/or around the electronic die 122 instead of opaque materials such as an encapsulant or a molding compound. For example, the dielectric material 126 may be formed from a suitably transparent material such as silicon oxide instead of an opaque material such as a molding compound. The use of a suitably transparent material for the dielectric material 126 in this manner allows optical signals to be transmitted through the dielectric material 126, such as transmitting optical signals between a grating coupler 107 and a vertically-mounted optical fiber (e.g., optical fiber 170 in FIG. 15) located above the dielectric material 126. Additionally, by directly bonding the electronic die 122 to the redistribution structure 120 in this manner, the thickness of the resulting photonic package 100 may be reduced, and the optical coupling between a grating coupler 107 and a vertically-mounted optical fiber may be improved. In some cases, this can reduce the size or processing cost of a photonic package, and the optical coupling to external components may be improved.

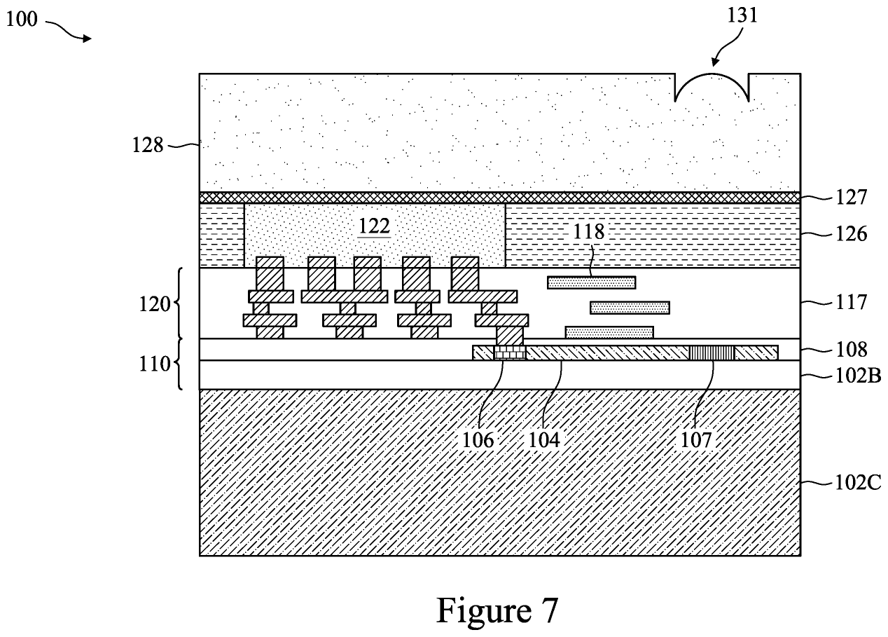

In FIG. 7, an optional support 128 is attached to the structure, in accordance with some embodiments. The support 128 is a rigid structure that is attached to the structure in order to provide structural or mechanical stability. The use of a support 128 can reduce warping or bending, which can improve the performance of the optical structures such as the waveguides 104 or photonic components 106. The support 128 may be attached to the structure (e.g., to the dielectric material 126 and/or the electronic dies 122) using a bonding layer 127 formed over the dielectric material 126 and the electronic dies 122, in accordance with some embodiments. The bonding layer 127 may be an adhesive layer or may be a dielectric layer used for dielectric-to-dielectric bonding of the support 128, for example. A dielectric bonding layer 127 may be a dielectric material suitable for bonding, which may be a material similar to those described previously for the dielectric layer 108 or a dielectric layer 117, in some cases. The bonding layer 127 may be deposited using similar techniques as the dielectric layer 108 or a dielectric layer 117. Other materials or deposition techniques are possible. In some embodiments, a planarization process is performed on the bonding layer 127. In other embodiments, a bonding layer 127 is not formed.

The support 128 may comprise one or more materials such as silicon (e.g., a silicon wafer, bulk silicon, or the like), a silicon oxide, a metal, an organic core material, the like, or another type of material. The support 128 may have a thickness in the range of about 500 μm to about 700 μm, in some embodiments. The support 128 may also have lateral dimensions (e.g., length, width, and/or area) that are greater than, about the same as, or smaller than those of the structure. In some embodiments, the support 128 includes a bonding layer (not separately illustrated), which may be an adhesive layer or a layer suitable for bonding to the bonding layer 127.

In some embodiments, the support 128 is formed of materials transparent to relevant wavelengths of light such that optical signals may be transmitted through the support 128. In the example of FIG. 7, an optional micro lens 131 is formed in the upper surface of the support 128. The micro lens 131 may facilitate improved optical coupling between a grating coupler 107 and a vertically-mounted optical fiber (e.g., optical fiber 170 in FIG. 15). In some embodiments, the micro lens 131 is formed in the support 128 using an etching process, such as a dry etching process or a wet etching process. In some embodiments, an index-matching material or the like (not shown) is deposited over the micro lens 131.

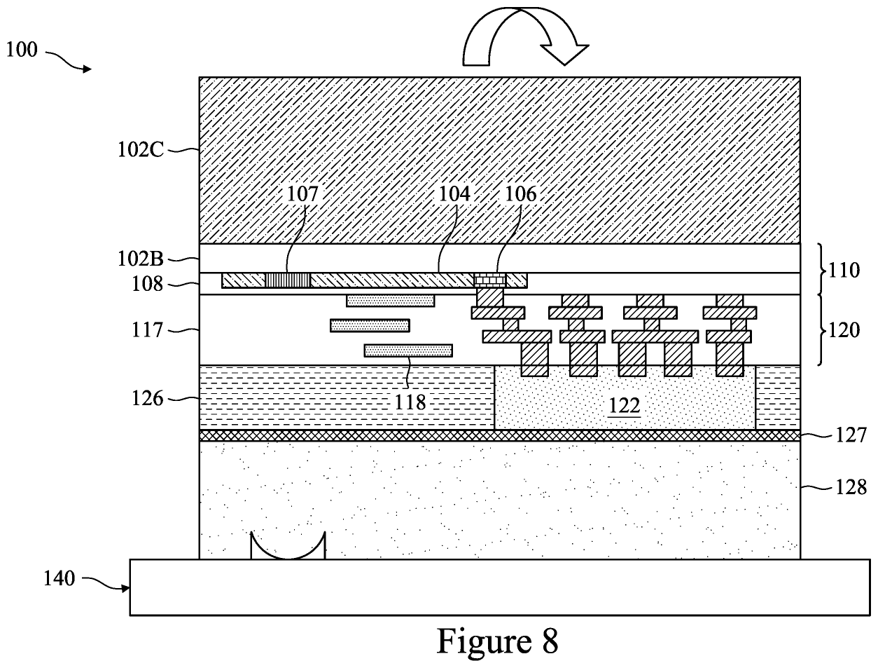

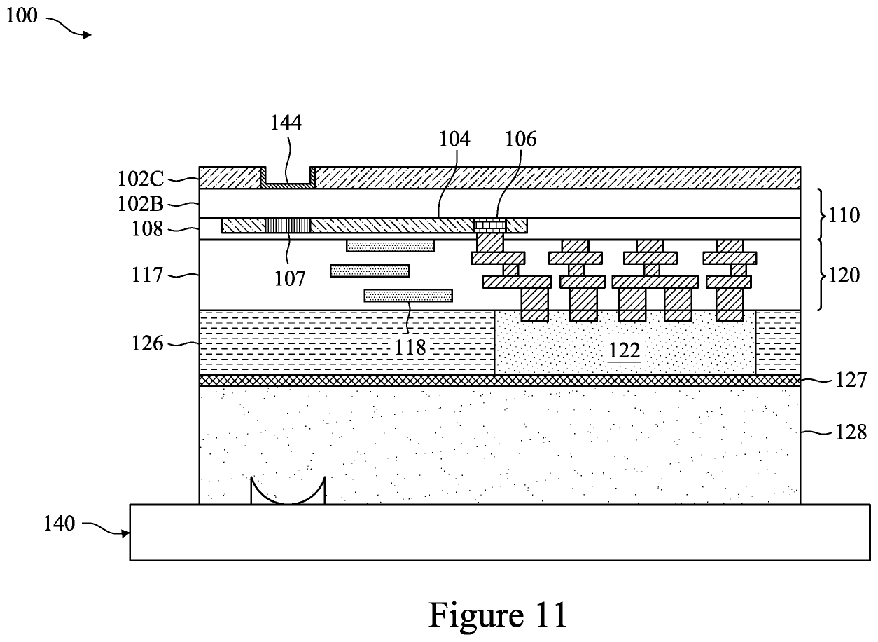

In FIG. 8, the structure in FIG. 11 is flipped over and attached to a carrier 140, in accordance with some embodiments. The carrier 140 may be, for example, a wafer (e.g., a silicon wafer), a panel, a glass substrate, a ceramic substrate, or the like. The structure may be attached to the carrier 140 using, for example, an adhesive or a release layer (not shown). Although one photonic package 100 is shown in FIG. 8, skilled artisan will appreciate that tens, hundreds, or more identical photonic packages may be formed over the carrier 140 at the same. In some embodiments, a singulation process is performed to separate the multiple photonic packages into individual photonic packages 100.

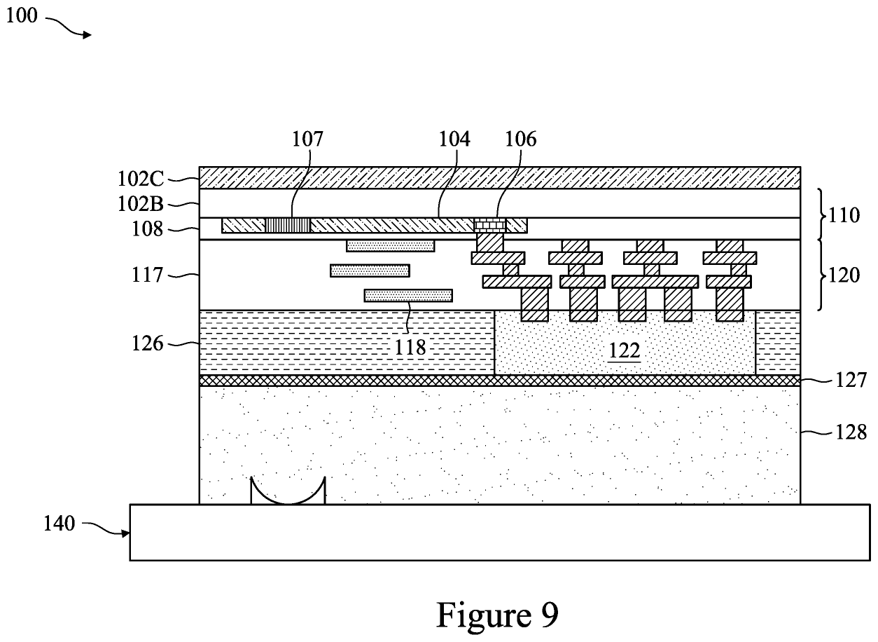

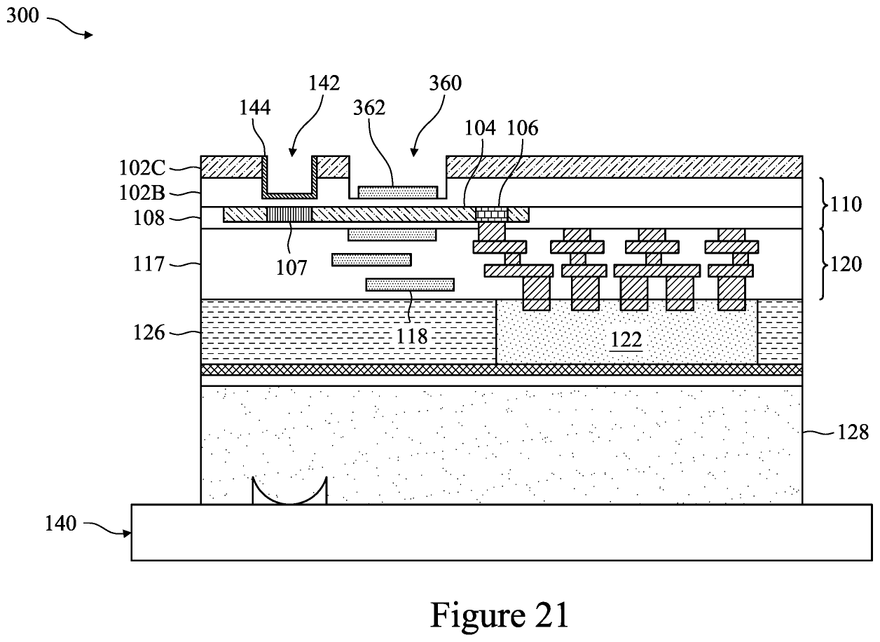

In FIG. 9, the substrate 102C is thinned, in accordance with some embodiments. The substrate 102C may be removed using a planarization process (e.g., a CMP or grinding process), an etching process, a combination thereof, or the like. In some embodiments, after thinning, the substrate 102C may have a thickness in the range of about 0.5 μm to about 3 μm. Other thicknesses are possible. In some cases, thinning the substrate 102C may improve optical coupling between a waveguide 104 and a nitride waveguide 362 (see FIG. 21).

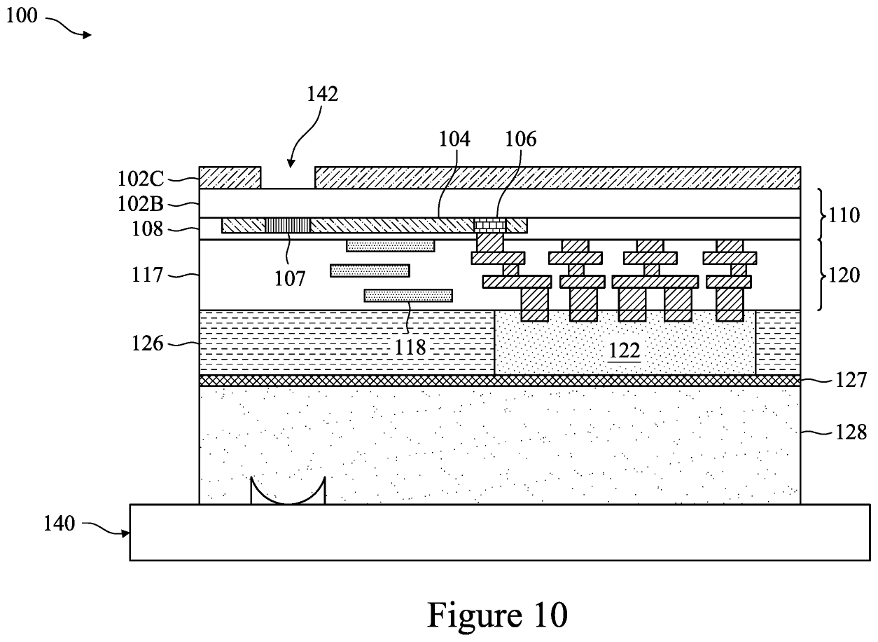

FIGS. 10 and 11 illustrate the formation of a reflector 144 (see FIG. 11), in accordance with some embodiments. The reflector 144 may be formed underneath a grating coupler 107 to reflect light from a vertically-mounted optical fiber (e.g., optical fiber 170 in FIG. 15) into the grating coupler 107. In this manner, the use of a reflector 144 can facilitate more efficient optical coupling of optical signals and/or optical power between a grating coupler 107 and a vertically-mounted optical fiber, which can improve device efficiency and operation. In some cases, forming a reflector 144 closer to the grating coupler 107 can further enhance the efficiency of optical coupling. In this manner, forming a reflector 144 within the thinned substrate 102C or the oxide layer 102B adjacent the grating coupler 107 as described herein, rather than within a more distant layer, can further improve the optical coupling.

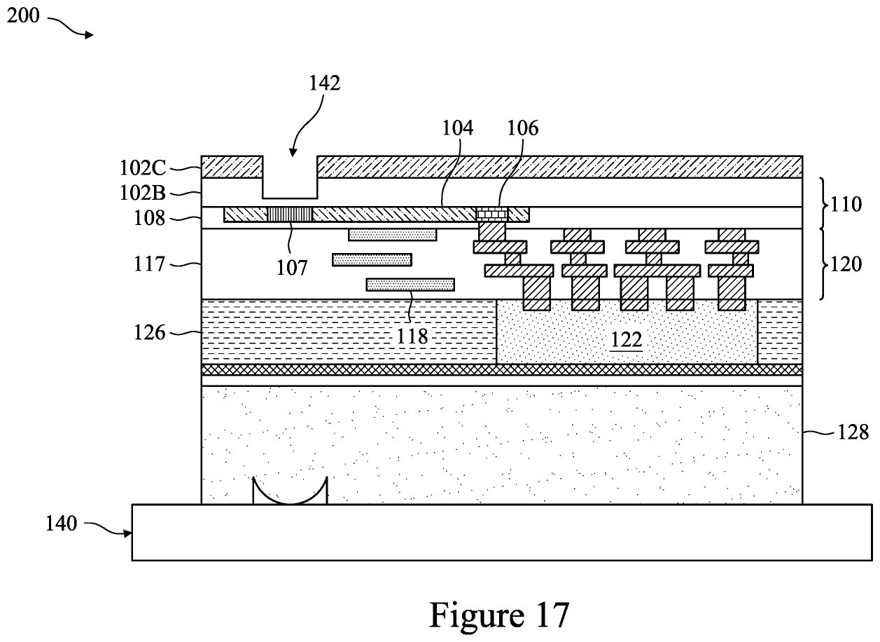

In FIG. 10, an opening 142 is formed in the thinned substrate 102C, in accordance with some embodiments. A reflector 144 is subsequently formed in the opening 142, and thus the opening 142 may laterally overlap a grating coupler 107, as shown in FIG. 10. The opening 142 may be approximately centered over the grating coupler 107, or may be laterally offset from the grating coupler 107. The opening 142 may have a width greater than, about the same as, or smaller than the a width of the grating coupler 107. The opening 142 may be formed using acceptable photolithography and etching techniques, such as by forming and patterning a photoresist and then performing an etching process using the patterned photoresist as an etching mask. The etching process may include, for example, a dry etching process and/or a wet etching process, which may be an anisotropic etch. In some embodiments, the opening 142 extends fully through the thinned substrate 102C and exposes the underlying oxide layer 102B, as shown in FIG. 10. In such embodiments, the etching process may include a selective etch that stops on the oxide layer 102B. In other embodiments, the opening 142 may extend partially through the thinned substrate 102C, leaving the oxide layer 102B covered by remaining portions of the thinned substrate 102C. In other embodiments, the opening 142 may also extend partially or fully through the oxide layer 102B. An example embodiment of the opening 142 extending into the oxide layer 102B is described below for FIGS. 17-19.

In FIG. 11, a reflective material is deposited in the opening 142 to form the reflector 144, in accordance with some embodiments. The reflective material may comprise metal materials or dielectric materials that are reflective to the relevant wavelengths of light. For example, in some embodiments, the reflective material may comprise a metal such as copper, silver, gold, tungsten, cobalt, aluminum, alloys thereof, a combination thereof, or the like. The metal may be deposited using a suitable process, such as sputtering, a plating process, CVD, or the like. In some embodiments, the metal may be deposited by first depositing a seed layer and then depositing the metal on the seed layer. In other embodiments, the reflective material may comprise a dielectric material such as silicon, silicon oxide, silicon nitride, titanium oxide, tantalum oxide, titanium nitride, tantalum nitride, a combination thereof, or the like. The dielectric material may be deposited using a suitable process, such as PVD, CVD, ALD, or the like. In some embodiments, the reflective material has a thickness in the range of about 10 nm to about 1000 nm, though other thicknesses are possible. In some embodiments, the reflective material may fill the opening 142. A planarization process (e.g., a CMP process or a grinding process) may be performed to remove excess reflective material. After performing the planarization process, top surfaces of the reflector 144 and the thinned substrate 102C may be substantially level or coplanar. In some embodiments, the reflective material has a reflectivity greater than about 90% for appropriate wavelengths of light, though other values are possible.

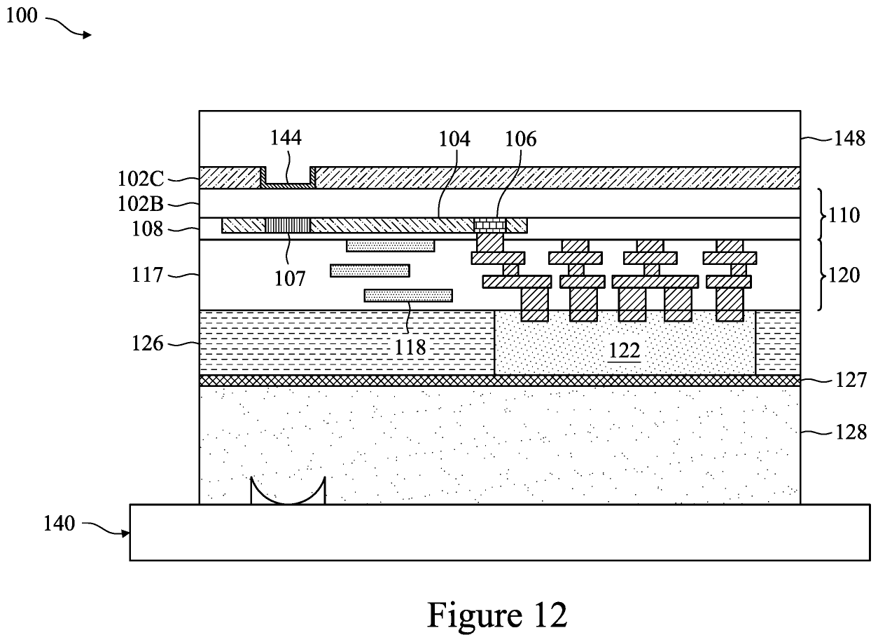

Turning to FIG. 12, a dielectric layer 148 is formed over the thinned substrate 102C and the reflector 144, in accordance with some embodiments. The dielectric layer 148 may comprise one or more materials similar to those described above for the dielectric layer 108, the dielectric layers 117, or the dielectric material 126. For example, the dielectric layer 148 may comprise a silicon oxide, spin-on glass, or the like. The dielectric layer 148 may be formed using a technique similar to those described previously, or may be formed using a different technique. For example, the dielectric layer 148 may be formed using CVD, PVD, spin-on, or the like, though another technique may be used. In some embodiments, a planarization process (e.g., a CMP or grinding process) is used to remove excess material of the dielectric layer 148. After planarization, the dielectric layer 148 may have a thickness between about 0.5 μm and about 2 μm, in some embodiments. Other thicknesses are possible. In other embodiments, the opening 142 is separately filled with a dielectric layer (not shown in the figures) prior to forming the dielectric layer 148.

In FIG. 13, vias 154 are formed extending through the dielectric layer 148, in accordance with some embodiments. The vias 154 may extend through the dielectric layer 148, the thinned substrate 102C, the oxide layer 102B, and the dielectric layer 108 to physically and electrically contact conductive features 114 of the redistribution structure 120. The vias 154 may be formed using materials or techniques similar to those described previously for forming the conductive features 114. For example, in some embodiments, openings may be formed extending through the thinned substrate 102C, the oxide layer 102B, and the dielectric layer 108 to expose surfaces of the conductive features 114. The openings may be formed using acceptable photolithography and etching techniques, such as by forming and patterning a photoresist and then performing an etching process using the patterned photoresist as an etching mask. The etching process may include, for example, a dry etching process and/or a wet etching process. A conductive material may then be formed in the openings, thereby forming the vias 154. In some embodiments, a liner (not shown) may be deposited in the openings prior to forming the conductive material. A planarization process (e.g., a CMP process or a grinding process) may be performed to remove excess conductive material along the top surface of the dielectric layer 148, such that top surfaces of the vias 154 and the dielectric layer 148 are level. Other materials or techniques are possible. In other embodiments, the vias 154 are omitted.

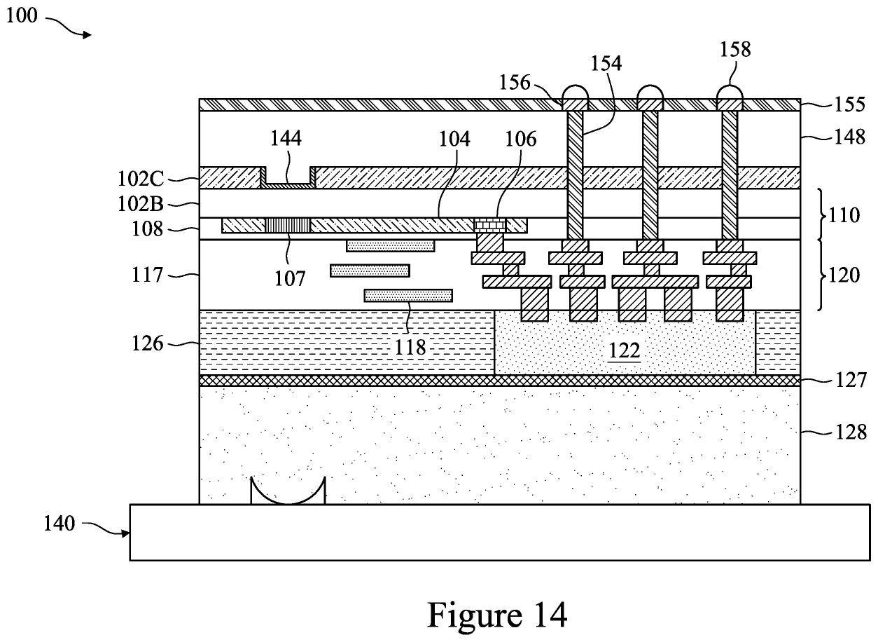

In FIG. 14, conductive connectors 158 are formed on the vias 154, in accordance with some embodiments. The conductive connectors 158 may be used to electrically connect the photonic package 100 to an external structure such as a package substrate, an organic core substrate, an interposer, or the like. In some embodiments, an optional passivation layer 155 is formed over the dielectric layer 148. The passivation layer 155 may comprise, for example, a polymer such as PBO, polyimide, BCB, or the like; a nitride such as silicon nitride or the like; an oxide such as silicon oxide, PSG, BSG, BPSG, or the like; an encapsulant, molding compound, or the like; the like, or a combination thereof. The passivation layer 155 may be formed, for example, by spin coating, lamination, CVD, PVD, ALD, or the like.

Under-bump metallizations (UBMs) 156 may then be formed within the passivation layer 155 to make physical and electrical contact to the vias 154. In other embodiments, the UBMs 156 are formed prior to forming the passivation layer 155. In some embodiments, the UBMs 156 have bump portions on and extending along the major surface of the passivation layer 155. The UBMs 156 may be formed of one or more conductive materials using a suitable process, such as plating. In some embodiments, the UBMs 156 are not formed.

The conductive connectors 158 are then formed on the UBMs 156, in accordance with some embodiments. The conductive connectors 158 may be, for example, ball grid array (BGA) connectors, solder balls, metal pillars, controlled collapse chip connection (C4) bumps, micro bumps, electroless nickel-electroless palladium-immersion gold technique (ENEPIG) formed bumps, or the like. The conductive connectors 158 may include a conductive material such as solder, copper, aluminum, gold, nickel, silver, palladium, tin, the like, or a combination thereof. In some embodiments, the conductive connectors 158 are formed by initially forming a layer of solder through evaporation, electroplating, printing, solder transfer, ball placement, or the like. Once a layer of solder has been formed on the structure, a reflow may be performed in order to shape the material into the desired bump shapes. In another embodiment, the conductive connectors 158 comprise metal pillars (such as a copper pillar) formed by a sputtering, printing, electro plating, electroless plating, CVD, or the like. The metal pillars may be solder free and have substantially vertical sidewalls. In some embodiments, a metal cap layer is formed on the top of the metal pillars. The metal cap layer may include nickel, tin, tin-lead, gold, silver, palladium, indium, nickel-palladium-gold, nickel-gold, the like, or a combination thereof and may be formed by a plating process. In other embodiments, the conductive connectors 158 are omitted and the UBMs 156 are bonding pads used for metal-to-metal bonding to an external component.

In FIG. 15, a de-bonding is performed to detach (or “de-bond”) the carrier 140 from the structure, forming a photonic package 100, in accordance with some embodiments. For example, the de-bonding may include projecting a light such as a laser light or an UV light on a release layer (if present) such that the release layer decomposes under the heat of the light and the carrier 140 can be removed. In other embodiments, the carrier 140 may be removed using an etching process, a CMP process, a grinding process, the like, or a combination thereof. In some embodiments, multiple photonic packages 100 may be formed on a single substrate 102 and singulated to form individual photonic packages 100, such as the individual photonic package 100 shown in FIG. 15. The singulation may be performed, for example, before or after the debonding.

Still referring to FIG. 15, the photonic package 100 is shown as coupled to a vertically-mounted optical fiber 170, in accordance with some embodiments. In other embodiments, another number of vertically-mounted optical fibers are coupled to the photonic package 100. The optical fibers 170 may be mounted to the photonic package 100 using an optical glue 171 or the like.

In some embodiments, the vertically-mounted optical fiber 170 may be optically coupled to a grating coupler 107 within the photonic package 100. The vertically-mounted optical fiber 170 may be mounted over the micro lens 131, in some embodiments. The vertically-mounted optical fiber 170 may be mounted at an angle with respect to the vertical axis or may be laterally offset from the grating coupler 107. In the embodiment shown in FIG. 14, the optical signals and/or optical power are transmitted between the vertically-mounted optical fiber 170 and the grating coupler 107, and are transmitted through the support 128 and any other intervening layers. As described previously, a reflector 144 such as described herein can improve the optical coupling between the optical fiber 170 and the grating coupler 107.

Optical signals may be transmitted, for example, from the optical fiber 170 to the grating coupler 107 and into one or more waveguides 104 or nitride waveguides 118, wherein the optical signals may be coupled into other nitride waveguides 118 and/or waveguides 104. The optical signals may be detected by a photonic component 106 comprising a photodetector and transmitted as electrical signals into the electronic die 122. Optical signals generated within the waveguides 104 by a photonic component 106 (e.g., a modulator) may be transmitted from the waveguides 104 to the grating coupler 107, and from the grating coupler 107 to the optical fiber 170. Mounting the optical fiber 170 in a vertical orientation may allow for improved optical coupling, reduced processing cost, or greater design flexibility of the photonic package 100.

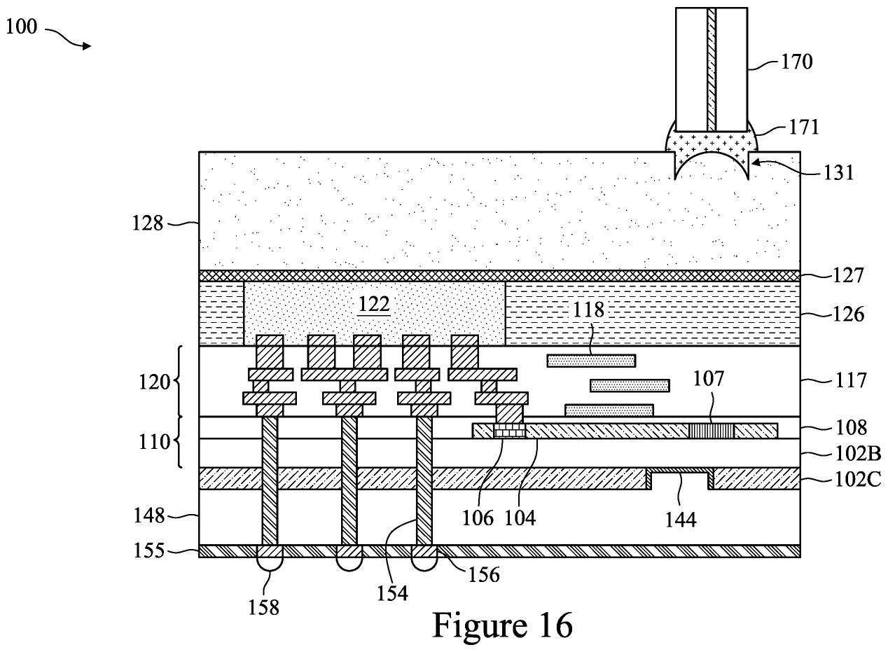

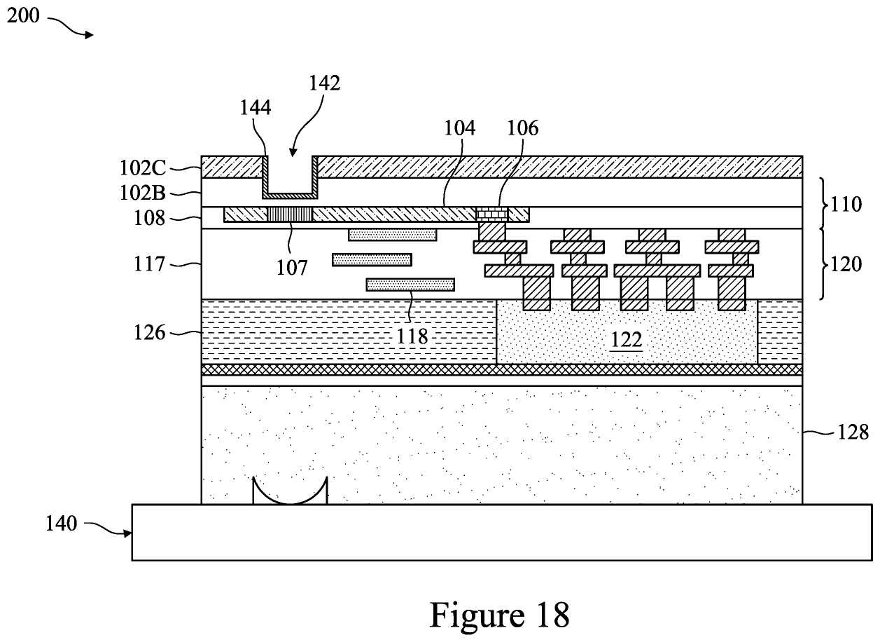

FIG. 16 illustrates a photonic package 100, in accordance with some embodiments. The photonic package 100 of FIG. 15 is similar to the photonic package 100 of FIG. 16, except that the reflector 144 is laterally offset from its corresponding grating coupler 107. A laterally offset reflector 144 may allow for the use of an angled optical fiber 170, for example, though a laterally offset reflector 144 may be utilized for other reasons. A laterally offset reflector 144 may partially overlap its corresponding grating coupler 107, as shown in FIG. 18, or it may not overlap its corresponding grating coupler 107.

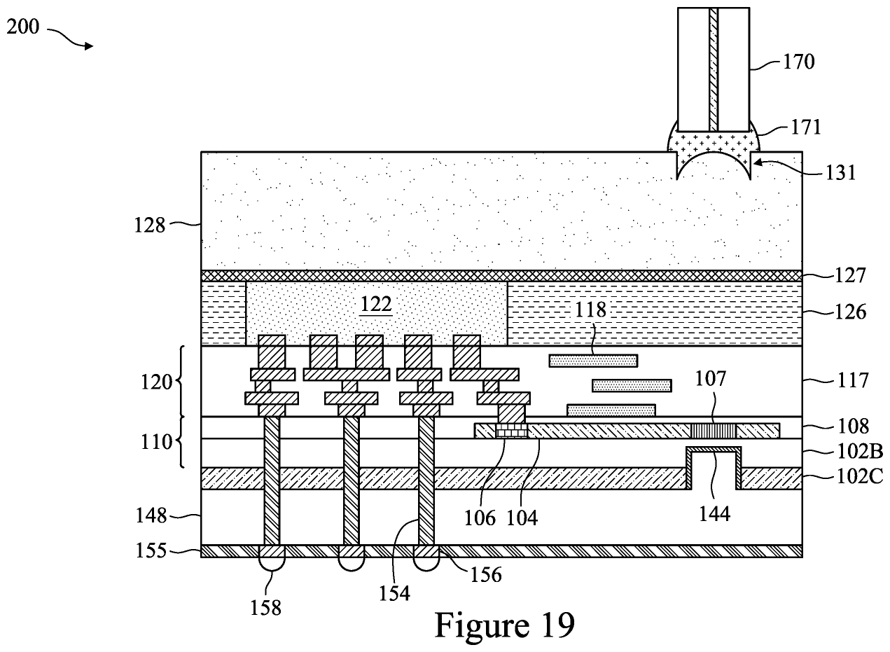

FIGS. 17 through 19 illustrate intermediate steps in the formation of a photonic package 200, in accordance with some embodiments. The photonic package 200 is similar to the photonic package 100 described previously for FIGS. 1 through 15, except that the reflector 144 extends through the thinned substrate 102C and into the oxide layer 102B. In some cases, forming a reflector 144 extending into the oxide layer 102B may allow for improved optical coupling between an optical fiber 170 (see FIG. 19) and a grating coupler 107. The photonic package 200 may be formed using materials or process steps similar to those described previously for the photonic package 100, and as such some details may not be repeated below.

FIG. 17 illustrates a structure similar to the structure shown in FIG. 10, except that the opening 142 extends through the thinned substrate 102C and partially into the oxide layer 102B. The opening 142 may be formed using techniques similar to those described previously, such as by using one or more photolithography and etching steps. In some embodiments, the remaining portion of the oxide layer 102B under the opening 142 may have a thickness in the range of about 0.1 μm to about 1.0 μm. Other thicknesses are possible. In other embodiments, the opening 142 may extend fully through the oxide layer 102B.

In FIG. 18, a reflector 144 is formed in the opening 142, in accordance with some embodiments. The reflector 144 may be formed using materials or techniques described previously. As shown in FIG. 18, portions of the reflector 144 may extend on sidewall surfaces of the thinned substrate 102C and the oxide layer 102B. In FIG. 19, subsequent processing steps are performed to form the photonic package 200, in accordance with some embodiments. The subsequent processing steps may be similar to those described previously for FIGS. 12 through 15, for example.

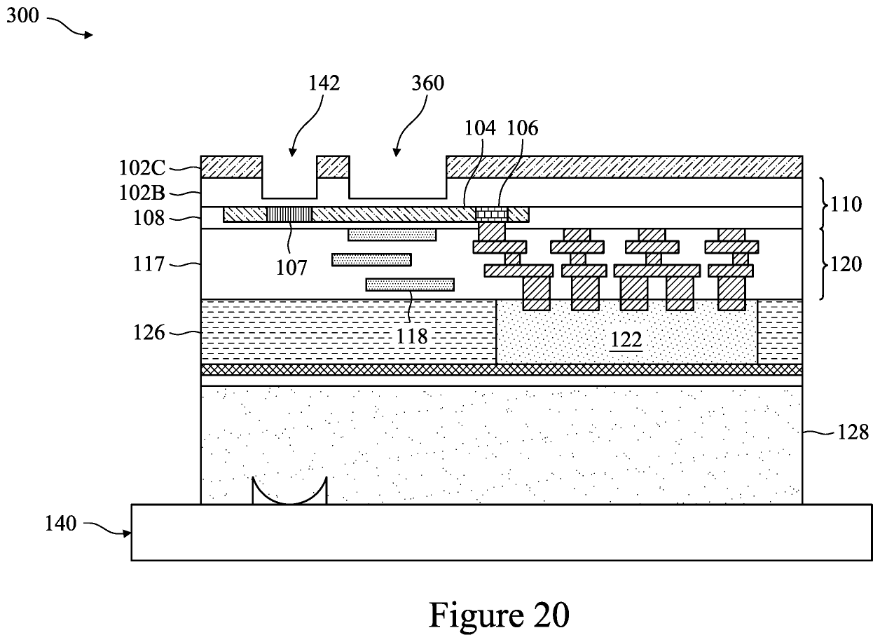

FIGS. 20 through 25 illustrate intermediate steps in the formation of a photonic package 300, in accordance with some embodiments. The photonic package 300 is similar to the photonic package 200 described previously for FIGS. 17-19, except that a photonic routing structure 320 comprising additional silicon nitride waveguides 362 is formed over the thinned substrate 102C. The nitride waveguides 362 provide additional optical signal routing and may be optically coupled to the waveguide 104, in some embodiments. The photonic package 300 may be formed using materials or process steps similar to those described previously for the photonic packages 100 or 200, and as such some details may not be repeated below. The number and arrangement of nitride waveguides 362 described and shown is an illustrative example, and other numbers or arrangements of nitride waveguides 362 are possible.

FIG. 20 illustrates a structure similar to the structure shown in FIG. 17, except that an opening 360 is formed in addition to the opening 142. The opening 360 extends through the thinned substrate 102C and partially into the oxide layer 102B, and is formed over a waveguide 104, in some embodiments. In other embodiments, multiple openings 360 are formed.

In FIG. 21, a reflector 144 is formed in the opening 142 and a nitride waveguide 362 is formed in the opening 360, in accordance with some embodiments. The reflector 144 may be formed before or after the nitride waveguide 362 is formed. The reflector 144 may be formed using techniques similar to those described previously for FIG. 18. In some embodiments, the opening 360 may be covered with a photoresist, a sacrificial material, or the like prior to deposition of the reflective material, which is removed after depositing the reflective material. The nitride waveguide 362 may be formed using materials or techniques similar to those described previously for the nitride waveguides 118. For example, a layer of silicon nitride may be deposited within the opening 360 and then patterned using photolithography techniques. In some embodiments, the opening 142 may be covered with a photoresist, a sacrificial material, or the like prior to deposition of the silicon nitride layer, which is removed after formation of the nitride waveguide 362. The nitride waveguide 362 formed on the oxide layer 102B may be optically coupled to the underlying waveguide 104, for example, such that optical signals or optical power may be transferred between the nitride waveguide 362 and the waveguide 104. The nitride waveguide 362 may be part of the photonic routing structure 320, described below for FIG. 23.

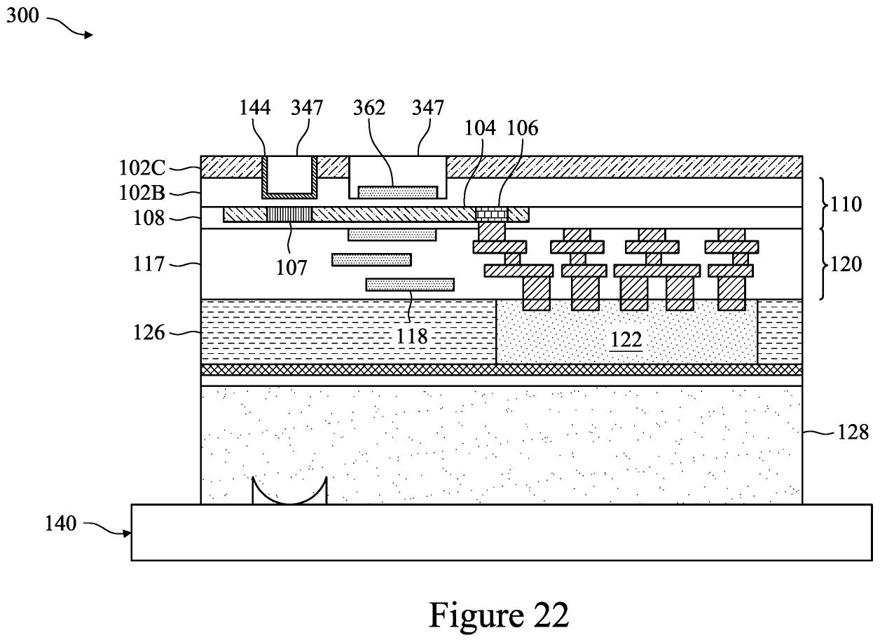

In FIG. 22, a dielectric layer 347 is deposited in the opening 142 and the opening 360, in accordance with some embodiments. The dielectric layer 347 may be similar to the dielectric layer 148 described previously, and may be formed using similar techniques. As shown in FIG. 23, the dielectric layer 347 may fill the opening 142 and the opening 360. In some embodiments, the dielectric layer 347 in the opening 142 may be formed using a separate deposition than the dielectric layer 347 in the opening 360. In some embodiments, a planarization process (e.g., a CMP process) may be performed to remove excess dielectric layer 347. In some embodiments, the planarization process may expose the thinned substrate 102C, in which case top surfaces of the dielectric layer 347 and the thinned substrate 102C may be level. In other embodiments, the thinned substrate 102C may remain covered by the dielectric layer 347 after performing the planarization process.

In FIG. 23, a photonic routing structure 320 comprising additional nitride waveguides 362 is formed over the thinned substrate 102C, in accordance with some embodiments. The photonic routing structure 320 includes one or more dielectric layers (collectively shown and referred to as “dielectric layers 348”) and includes nitride waveguides 362 formed in the dielectric layers 348 that provide routing of optical signals and/or optical power, in accordance with some embodiments. The nitride waveguides 362 may be optically coupled to the waveguide 104, for example, by the nitride waveguide 362 that was previously formed in the opening 360. The nitride waveguides 362 may be formed using materials or techniques similar to those described previously for the nitride waveguides 118. For example, a silicon nitride layer may be deposited over a dielectric layer 348 and patterned to form nitride waveguide(s) 362. Another dielectric layer 348 may then be deposited over the nitride waveguide(s) 362. These process steps may be repeated to form multiple layers of nitride waveguides 362 within dielectric layers 348.

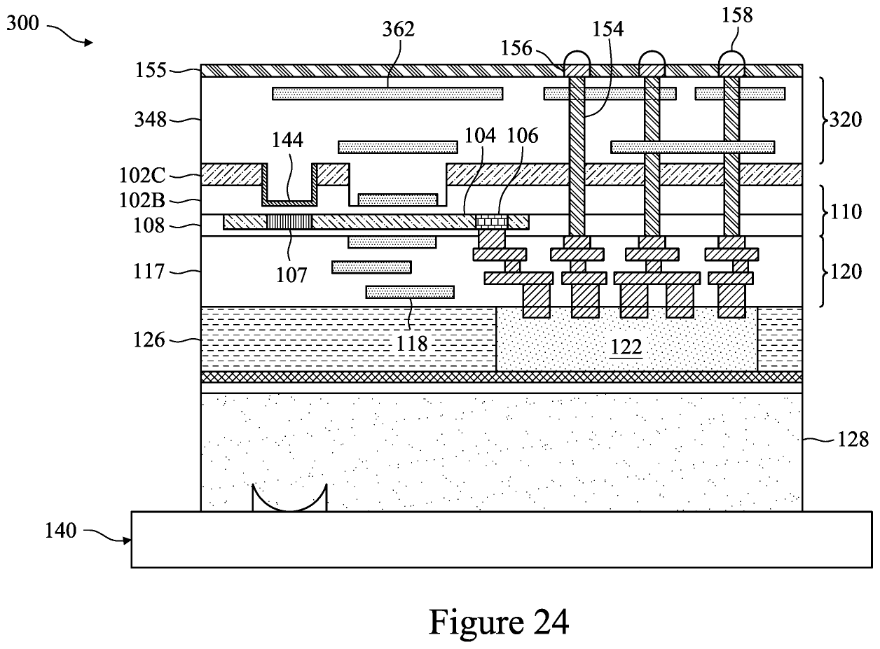

In FIG. 24, vias 154 and conductive connectors 158 are formed, in accordance with some embodiments. The vias 154 and conductive connectors 158 may be formed using techniques similar to those described previously for FIGS. 13-14. For example, the vias 154 may extend through the photonic routing structure 320 to physically and electrically contact conductive features 114 of the redistribution structure 120. In this manner, a photonic package 300 comprising both a reflector 144 and a photonic routing structure 320 may be formed. Other photonic packages, process steps, configurations, or arrangements are possible.

Embodiments may achieve advantages. The formation of a reflector beneath a grating coupler can improve the optical coupling between the grating coupler and an overlying optical structure, such as an optical fiber or another grating coupler. By forming a reflector within a photonic package as described herein, the efficiency of the photonic package can be improved. The reflector described herein can allow for less optical noise or less optical loss when transmitting optical signals or optical power to or from a grating coupler. Additionally, the techniques described herein allow for the formation of a reflector that is close to its grating coupler, which can further increase the optical coupling efficiency. The techniques described herein can allow for a reflector to be formed in addition to other structures, such as silicon nitride waveguides, photonic routing structures, redistribution structures, or the like. In some cases, the reflector may also act as a heat dissipator, which can improve the thermal performance of a photonic package.

In accordance with some embodiments of the present disclosure, a method includes forming a waveguide over a top surface of a dielectric layer, wherein the dielectric layer is on a substrate; forming a grating coupler over the top surface of the dielectric layer, wherein the grating coupler is optically coupled to the waveguide; thinning the substrate; forming a recess in the substrate being thinned, wherein the recess laterally overlaps the grating coupler; and depositing a reflective material in the recess, wherein the reflective material has a reflectivity of at least 90%. In an embodiment, the method includes forming a redistribution structure over the waveguide. In an embodiment, the method includes forming a photonic device on the top surface of the dielectric layer, wherein the redistribution structure is electrically connected to the photonic device. In an embodiment, the method includes forming a silicon nitride waveguide over the waveguide, wherein the silicon nitride waveguide is optically coupled to the waveguide. In an embodiment, the waveguide is a silicon waveguide and the dielectric layer is an oxide layer. In an embodiment, the recess extends into the dielectric layer. In an embodiment, a portion of the recess laterally extends beyond an edge of the grating coupler. In an embodiment, the method includes attaching an optical fiber over the grating coupler, wherein the optical fiber is optically coupled to the grating coupler.

In accordance with some embodiments of the present disclosure, a method includes receiving a workpiece that includes a substrate, a first dielectric layer over the substrate, and an optical layer over the dielectric layer; patterning the optical layer to form a first waveguide and a grating coupler; forming a first opening in the substrate that exposes the first dielectric layer, wherein at least a portion of the first opening is directly over the grating coupler; depositing a metal layer in the first opening; and depositing a second dielectric layer over the metal layer. In an embodiment, the method includes thinning the substrate before forming the first opening in the substrate. In an embodiment, the method includes forming a second opening in the substrate that exposes the first dielectric layer, wherein at least a portion of the second opening is directly over the first waveguide; and forming a second waveguide in the second opening, wherein the second waveguide is optically coupled to the first waveguide. In an embodiment, the method includes forming a photonic routing structure over the second waveguide, wherein the photonic routing structure includes a third waveguide that is optically coupled to the second waveguide. In an embodiment, the second waveguide is a different material than the first waveguide. In an embodiment, a distance between a bottom surface of the first opening and a surface of the grating coupler is in the range of 0.1 μm to 1.0 μm. In an embodiment, the metal layer includes at least one of gold, copper, silver, tungsten, cobalt, aluminum, or an alloy thereof.

In accordance with some embodiments of the present disclosure, a package includes a silicon layer; a reflective structure within the silicon layer; a first photonic routing structure over a first side of the silicon layer, wherein the first photonic routing structure includes an insulating layer on the first side of the silicon layer; a silicon waveguide on the insulating layer; a photonic device on the insulating layer; and a grating coupler on the insulating layer, wherein the grating coupler is directly over the reflective structure; a redistribution structure on the first photonic routing structure, wherein the redistribution structure is electrically connected to the photonic device; and an electronic die on the redistribution structure, wherein the electronic die is electrically connected to the redistribution structure. In an embodiment, the package includes first nitride waveguides within the redistribution structure, wherein at least one first nitride waveguide of the first nitride waveguides is optically coupled to the silicon waveguide. In an embodiment, the package includes a second photonic routing structure over a second side of the silicon layer, wherein the second photonic routing structure second nitride waveguides, wherein at least one second nitride waveguide of the second nitride waveguides is optically coupled to the silicon waveguide. In an embodiment, the package includes a via extending through the second photonic routing structure, wherein the via is electrically connected to the redistribution structure. In an embodiment, the package includes a support structure over the electronic die, wherein the support structure includes a lens, wherein the lens is configured to optically couple an optical fiber to the grating coupler.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
forming a waveguide over a top surface of a dielectric layer, wherein the dielectric layer is on a substrate;
forming a grating coupler over the top surface of the dielectric layer, wherein the grating coupler is optically coupled to the waveguide;
thinning the substrate;
forming a recess in the substrate being thinned, wherein the recess laterally overlaps the grating coupler; and
depositing a reflective material in the recess, wherein the reflective material has a reflectivity of at least 90%.

2. The method of claim 1 further comprising forming a redistribution structure over the waveguide.

3. The method of claim 2 further comprising forming a photonic device on the top surface of the dielectric layer, wherein the redistribution structure is electrically connected to the photonic device.

4. The method of claim 1 further comprising forming a silicon nitride waveguide over the waveguide, wherein the silicon nitride waveguide is optically coupled to the waveguide.

5. The method of claim 1, wherein the waveguide is a silicon waveguide and the dielectric layer is an oxide layer.

6. The method of claim 1, wherein the recess extends into the dielectric layer.

7. The method of claim 1, wherein a portion of the recess laterally extends beyond an edge of the grating coupler.

8. The method of claim 1 further comprising attaching an optical fiber over the grating coupler, wherein the optical fiber is optically coupled to the grating coupler.

9. A method comprising:
receiving a workpiece comprising a substrate, a first dielectric layer over the substrate, and an optical layer over the dielectric layer;
patterning the optical layer to form a first waveguide and a grating coupler;
forming a first opening in the substrate that exposes the first dielectric layer, wherein at least a portion of the first opening is directly over the grating coupler;
depositing a metal layer in the first opening; and
depositing a second dielectric layer over the metal layer.

10. The method of claim 9 further comprising thinning the substrate before forming the first opening in the substrate.

11. The method of claim 9 further comprising:
forming a second opening in the substrate that exposes the first dielectric layer, wherein at least a portion of the second opening is directly over the first waveguide; and
forming a second waveguide in the second opening, wherein the second waveguide is optically coupled to the first waveguide.

12. The method of claim 11 further comprising forming a photonic routing structure over the second waveguide, wherein the photonic routing structure comprises a third waveguide that is optically coupled to the second waveguide.

13. The method of claim 11, wherein the second waveguide is a different material than the first waveguide.

14. The method of claim 9, wherein a distance between a bottom surface of the first opening and a surface of the grating coupler is in the range of 0.1 μm to 1.0 μm.

15. The method of claim 9, wherein the metal layer comprises at least one of gold, copper, silver, tungsten, cobalt, aluminum, or an alloy thereof.

16. A package comprising:
a silicon layer;
a reflective structure within the silicon layer;
a first photonic routing structure over a first side of the silicon layer, wherein the first photonic routing structure comprises:
an insulating layer on the first side of the silicon layer;
a silicon waveguide on the insulating layer;
a photonic device on the insulating layer; and
a grating coupler on the insulating layer, wherein the grating coupler is directly over the reflective structure;
a redistribution structure on the first photonic routing structure, wherein the redistribution structure is electrically connected to the photonic device; and
an electronic die on the redistribution structure, wherein the electronic die is electrically connected to the redistribution structure.

17. The package of claim 16 further comprising a plurality of first nitride waveguides within the redistribution structure, wherein at least one first nitride waveguide of the plurality of first nitride waveguides is optically coupled to the silicon waveguide.

18. The package of claim 16 further comprising a second photonic routing structure over a second side of the silicon layer, wherein the second photonic routing structure comprises a plurality of second nitride waveguides, wherein at least one second nitride waveguide of the plurality of second nitride waveguides is optically coupled to the silicon waveguide.

19. The package of claim 18 further comprising a via extending through the second photonic routing structure, wherein the via is electrically connected to the redistribution structure.

20. The package of claim 16 further comprising a support structure over the electronic die, wherein the support structure comprises a lens, wherein the lens is configured to optically couple an optical fiber to the grating coupler.
